(19) United States
(12) Patent Application Publication
(10) Pub. No.: US 2024/0280132 A1
(43) Pub. Date: Aug. 22, 2024

(54) FASTENER ASSEMBLY AND METHOD FOR SECURING TOGETHER TWO PANELS

(71) Applicants: NED C. BOWERS, Mount Dora, FL (US); Russell Ortner, Apopka, FL (US)

(72) Inventors: NED C. BOWERS, Mount Dora, FL (US); Russell Ortner, Apopka, FL (US)

(21) Appl. No.: 18/442,911

(22) Filed: Feb. 15, 2024

Related U.S. Application Data
(60) Provisional application No. 63/446,597, filed on Feb. 17, 2023.

(51) Int. Cl. F16B 37/12; F16B 5/02

(52) U.S. Cl. CPC F16B 37/12; F16B 5/02

(57) ABSTRACT

A fastener assembly, including: a nut plate (22) that defines a channel (36) therein; a U-shaped clip (20) configured to cooperate with notches (38, 40) in walls (32, 34) of the nut plate to clip thereon; and an insert (18) with female threads. The clip (20) retains the insert (18) in the channel and defines an opening (42) through which the insert can be forced to move the insert out of or into the channel. The nut plate (22) and clip (20) can retain various inserts with different size female threads.

### FIELD OF THE INVENTION

The present invention relates to fastener assemblies that are used to secure together two panels, and methods for securing together two panels. More particularly, invention pertains to such assemblies and methods that utilize a nut plate in combination with a resilient retaining device and an internally threaded insert to receive a fastener such as a bolt.

### BACKGROUND

In the aerospace industry and racing car industry fastener assemblies are used to secure together two overlapping panels. Typically, multiple of the assemblies are aligned along an edge of the panel and with respective holes in the panels for assembly. The assemblies generally include a nut plate (a/k/a cage) that is bonded or fastened to a blind side of one of the two panels. The nut plate may be bonded using known adhesives or fastened with rivets.

An internally threaded insert is secured to the nut plate with a resilient retaining device such as a clip. A bolt is then inserted through holes in both panels, and with which the nut plates and inserts are aligned and threaded into the insert.

Some of these fasteners last only about five cycles and must be replaced, which may require drilling out the rivets or debonding the nut plate, which is time consuming and labor intensive. In some cases, the insert is removable the retainer device may be removed with the insert, which may require a tool. However, the resilient or spring characteristic nature of the retention device, it is often difficult to hold and retain and is lost creating FOD (foreign object damage), which refer to any object, live or not, located in an inappropriate location in the airport environment that has the capacity to injure airport or air carrier personnel and damage aircraft.

### SUMMARY OF THE INVENTION

In accordance with aspects of the invention, a fastener assembly may comprise a nut plate having a planar base plate comprising a first end, a second end, a first hole at and through the first end, and a second hole at and through the second end. A planar first wall is cantilevered from and perpendicular to the base plate; and, a planar second wall cantilevered from and perpendicular to the base plate and parallel to the first wall, wherein the base plate, first wall and second wall define a channel. In addition, a third hole is through the base plate between the first wall and the second wall.

In an embodiment, the first wall comprises a first pair notches comprising a first notch disposed toward the first end of the base plate and a second disposed toward the second end of the base plate, wherein the second wall comprises a second pair of notches comprising a first notch disposed toward the first end of the base plate and a second disposed toward the second end of the base plate. The first notches of the first and second pairs of notches are dimensioned the same and the second notches of the first and second pairs of notches are dimensioned the same, and the respective first notches each have a length dimension that is the same and is greater than a length dimension of the respective second notches of first and second pairs of notches.

The fastener assembly also includes a resilient retention device comprising a generally U-shaped configuration with two parallel legs interconnected by a third leg and respective ends of the two parallel legs are seated in a respective first notch of the first pair of notches and extend along outside surfaces of the first and second walls relative to the channel. The third leg is seated in the second notches of the respective pairs of notches and span the channel.

A receptacle is disposed in the channel and comprises a hollow cylinder with a through-hole aligned with the third hole of the based plate. The hollow cylinder comprises internal threading, wherein the receptacle is a component separate from the nut plate and retained in the channel at least by the retention device.

According to other aspects of the invention, a fastener assembly may include a nut plate having a planar base plate comprising a first end, a second end, a first hole at and through the first end, and a second hole at and through the second end. The planar first wall is integral with the base plate and depends therefrom perpendicular to the base plate; and a planar second wall integral with base plate and depends therefrom perpendicular to the base plate and parallel to the first wall, wherein the base plate, first wall and second wall define a channel.

In addition, there is a resilient retention device that comprises a generally U-shaped configuration with spaced apart legs interconnected by a third leg. The retention device is seated against the first wall and the second wall, wherein the two spaced apart legs form an opening at an end of the retention device within the channel and between the first and second walls, and the opening comprises a width dimension. The first wall comprises a notch at a first end thereof, and the second wall comprises a notch at a first end of the wall opposite the notch of the first wall, and the notches in the first wall and the second wall have a bottom surface that is spaced an equidistance from a top surface of the planar base plate of the nut plate.

In an embodiment a plurality of inserts are provided comprising at least a first insert and a second insert wherein each of the first insert and second insert comprises an internally threaded cylinder integrally connected to a respective planar base and a respective shoulder is disposed between the cylinder and the base. The planar base of the first insert comprises a width dimension that is equal to a width dimension of the planar base of the second insert. The shoulder of the first insert (which may be a 8×32 insert/cylinder/receptacle) comprises an outside diameter and a height dimension that is equal to an outside diameter and a height dimension of the shoulder of the second insert (which may be a 10×32 insert/cylinder/receptacle), and wherein the outside diameter of the first respective shoulders is greater than the width dimension of the opening of the retention device in the channel, and the height of the shoulder of each of the first insert and second insert is greater than the equidistance the notches are spaced from the top surface of the base plate. The cylinder of the first insert comprises a first internal thread size that is not equal to a second internal thread size of the cylinder of the second insert; and

The first insert and second insert are interchangeable in the channel of the nut plate whereby the first insert is capable of being positioned and secured in the channel of the nut plate and secured therein by the retention device separate and apart from the second insert. To that end, the second insert is capable of being positioned and secured in the channel of nut plate and secured therein separate and apart from the first insert.

In an embodiment, the fastener assembly may comprise a third insert that is interchangeable on the nut plate relative to the first insert and the second insert, and the third insert comprises an internally threaded cylinder integrally connected to a respective planar base. The planar base of the third insert comprises a width dimension that is equal to the width dimension of the planar base of the first insert and the second insert. The cylinder of the third insert (which may be a ¼×28 insert/cylinder/receptacle) comprises an outside diameter that is equal to the outside diameter of the shoulder of the first insert and the outside diameter of the shoulder of the second insert, and the outside diameter of the cylinder of the third insert is greater than the width dimension of the opening of the retention device in the channel. The cylinder of the third insert comprises a third internal thread size that is not equal to the first internal thread size of the cylinder of the first insert and is not equal to the second internal thread size of the cylinder of the second insert.

According to aspects of the invention, a fastener assembly comprises a nut plate having a planar base plate comprising a first end and a second end. A planar first wall cantilevered from and perpendicular to the base plate; and, a planar second wall cantilevered from and perpendicular to the base plate and parallel to the first wall. The base plate, first wall and second wall define a channel and a hole is through the base plate between the first wall and the second wall.

In addition, a resilient retention device comprises a generally U-shaped configuration with spaced apart legs interconnected by a third leg and the retention device is seated against the first wall and the second wall. The two spaced apart legs form an opening at an end of the retention device within the channel and between the first and second walls, wherein the opening comprises a width dimension. The first wall has a notch at a first end thereof, and the second wall comprises a notch at a first end of the wall opposite the notch of the first wall, and the notches in the first wall and the second wall each have a bottom surface that is spaced an equidistance from a top surface of the planar base plate of the nut plate.

A plurality of inserts is provided including at least a first insert and a second insert wherein each of the first insert and second insert comprises an internally threaded receptacle and the receptacle is integrally connected to a planar base. The planar base of the first insert comprises a width dimension that is equal to a width dimension of the planar base of the second insert. The receptacle of the first insert comprises an outside diameter that is greater than the width dimension of the opening of the between the two spaced apart legs of the retention device, and the receptacle of the second insert comprises an outside diameter that is greater than the width dimension of the opening of the between the two spaced apart legs of the retention device. The receptacle of the first insert comprises a first internal thread size that is not equal to a second internal thread size of the receptacle of the second insert. Accordingly, the first insert and second insert are interchangeable in the channel of the nut plate whereby the first insert is capable of being positioned and secured in the channel of the nut plate and secured therein by the retention device separate and apart from the second insert and the second insert is capable of being positioned and secured in the channel of nut plate and secured therein separate and apart from the first insert. In addition, the receptacle of the first insert (8×32 receptacle) comprises a hollow internally threaded cylinder and a shoulder between the cylinder and the base, and the outside diameter of the receptacle is defined by the shoulder, and the receptacle of the second insert (10×32 receptacle) comprises a hollow internally threaded cylinder and a shoulder between the cylinder and the base, and the outside diameter of the receptacle is defined by the shoulder.

In addition, the fastener assembly may comprise a third insert that comprises an internally threaded receptacle integrally connected to a respective planar base, and the receptacle of the third insert (¼-28 receptacle) comprises a hollow internally threaded cylinder and a shoulder between the cylinder and the base, and an outside diameter of the receptacle is defined by the shoulder and is equal to the outside diameter of the first insert and the outside diameter of the second insert. The planar base of the third insert comprises a width dimension that is equal to the width dimension of the planar base of the first insert and the second insert; and the first insert, second insert and third insert are interchangeable in the channel of the nut plate.

### DESCRIPTION OF THE DRAWINGS

FIG. 1 is an exploded perspective view of an embodiment of a fastener assembly and representative panels according to aspects of the invention.

FIG. 2 is an exploded perspective view of the fastener assembly without the panels.

FIG. 3A to FIG. 3D are views of the fastener assembly installed on the panels.

FIG. 4A to FIG. 4D are views of the fastener assembly with an insert and retention device on a nut plate.

FIG. 5A to FIG. 5D are views of the nut plate of the previous figures.

FIG. 6 is a top view of the nut plate in stamped form.

FIG. 7A to FIG. 7D are top, side and perspective views of a retention device (clip) according to aspects of the invention.

FIG. 8A to FIG. 8D are top, side, sectional and perspective views of an example embodiment of an 8×32 insert according to aspects of the invention.

FIG. 9A to FIG. 9D are top, side, sectional and perspective views of an example embodiment of a 10×32 insert according to aspects of the invention.

FIG. 10A to FIG. 10D are top, side, sectional and perspective views of an example embodiment of a ¼×28 insert according to aspects of the invention.

FIG. 11A to FIG. 11D are top views of fastener assemblies using the inserts of FIG. 8A, FIG. 9A, and FIG. 10A.

### DETAILED DESCRIPTION

A method and apparatus or system are described for securing together two panels. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4. Additionally, the term “orthogonal” is used to indicate an angle between two directions in a range of 90 degrees±10 degrees or in a range of 90 degrees±20 degrees. Additionally, the term “parallel” is used to indicate an angle between two directions in a range of 0 degrees±10 degrees or in a range of 0 degrees±20 degrees.

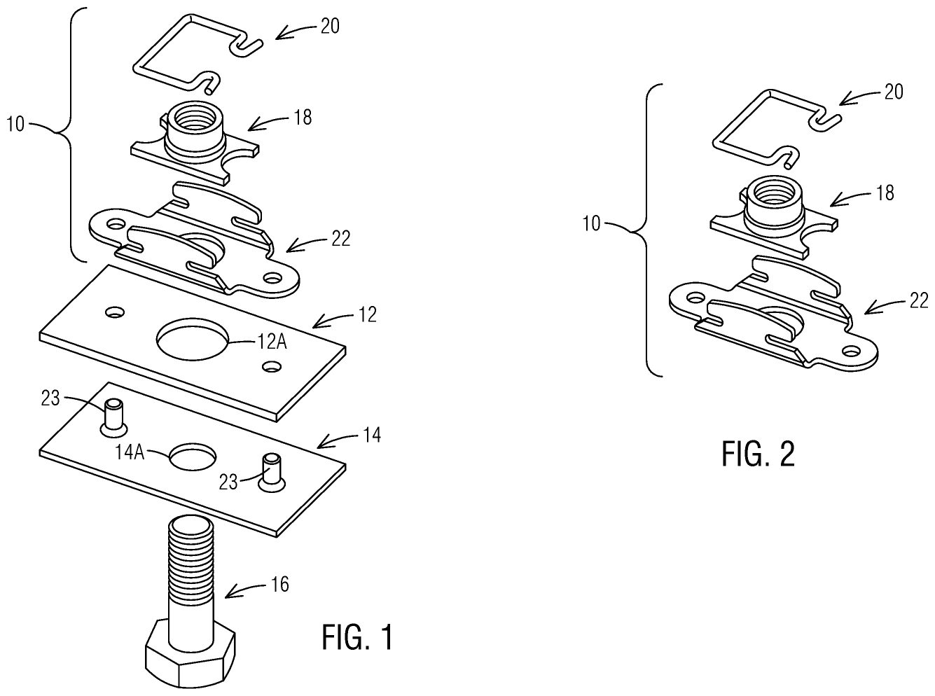

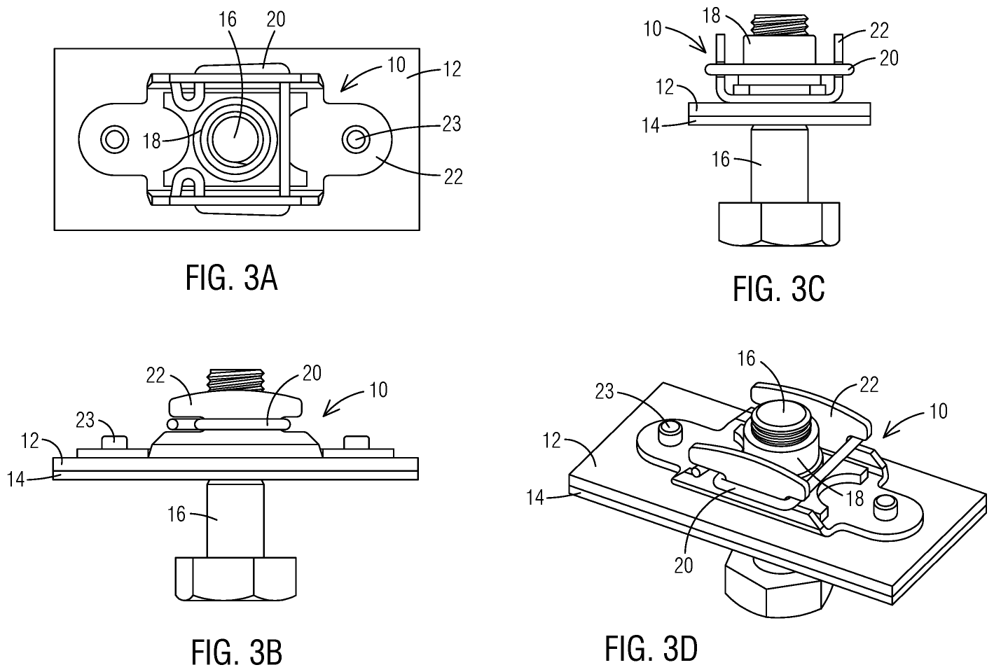

With respect to FIGS. 1-3D, an embodiment of a fastener assembly 10 is shown for securing together two panels including a first panel 12 and a second panel 14. The fastener assemblies 10 utilize a bolt 16 to secure the first panel 12 to the second panel 14 and an internally threaded insert 18 for receiving a threaded portion of the bolt 16. A resilient retainer clip 20 secures the insert 18 against a nut plate 22, which is, in turn, mounted to one of the panels 12, 14 with known fastening systems such as rivets, bonding adhesives, etc. The bolt 16 is inserted through holes 12A, 14A of the panels 12, 14 and threaded into the insert 18 to secure at least portions of the panels 12, 14 together. In a typical installation, for example securing together panels of an airplane, such as floorboard panels, multiple fastener assemblies 10 are aligned and installed to secure the panels to one another. The nut plate 22 may be mounted to the panel 12 using fastener components such as rivets 23. Alternatively, the nut plate 22 may be mounted to the panel 12 or 14 using a bonding adhesive, for example. However, the invention is not limited to a particular method or mechanism for securing the nut plate 22 one of the panels 12 or 14.

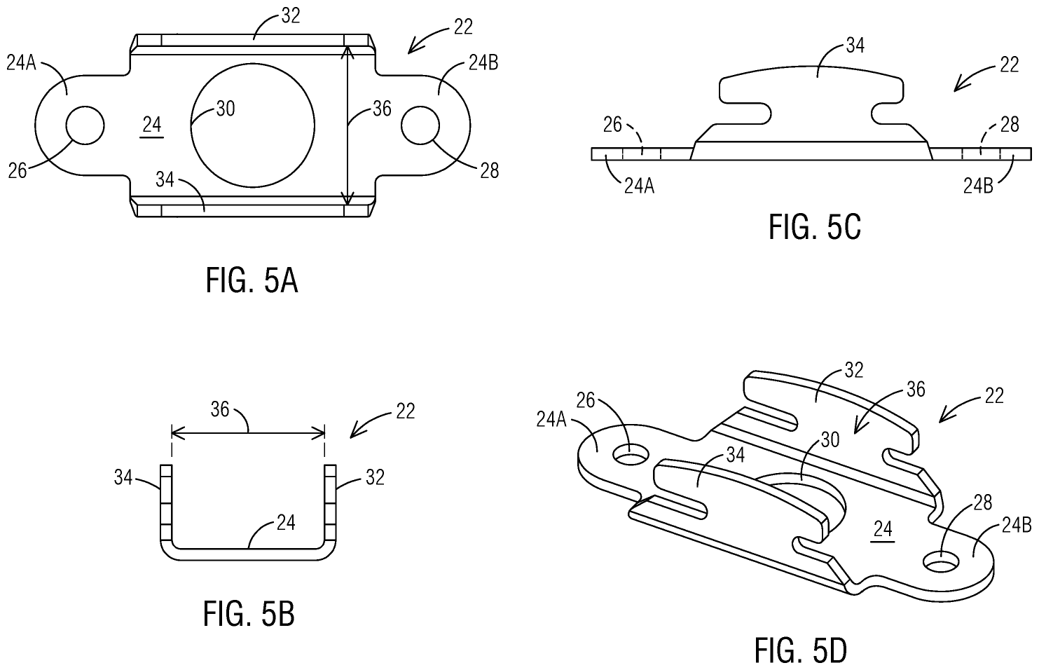

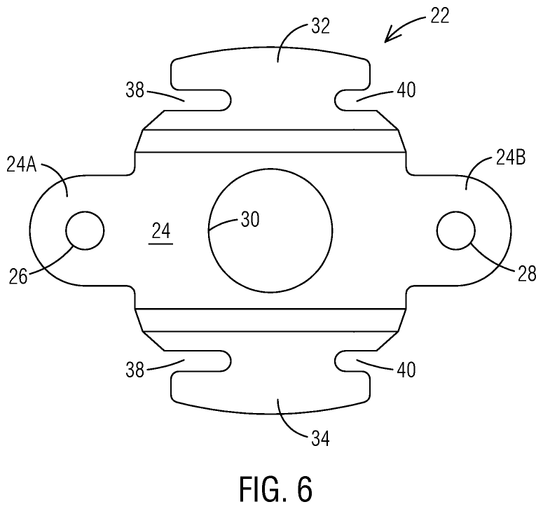

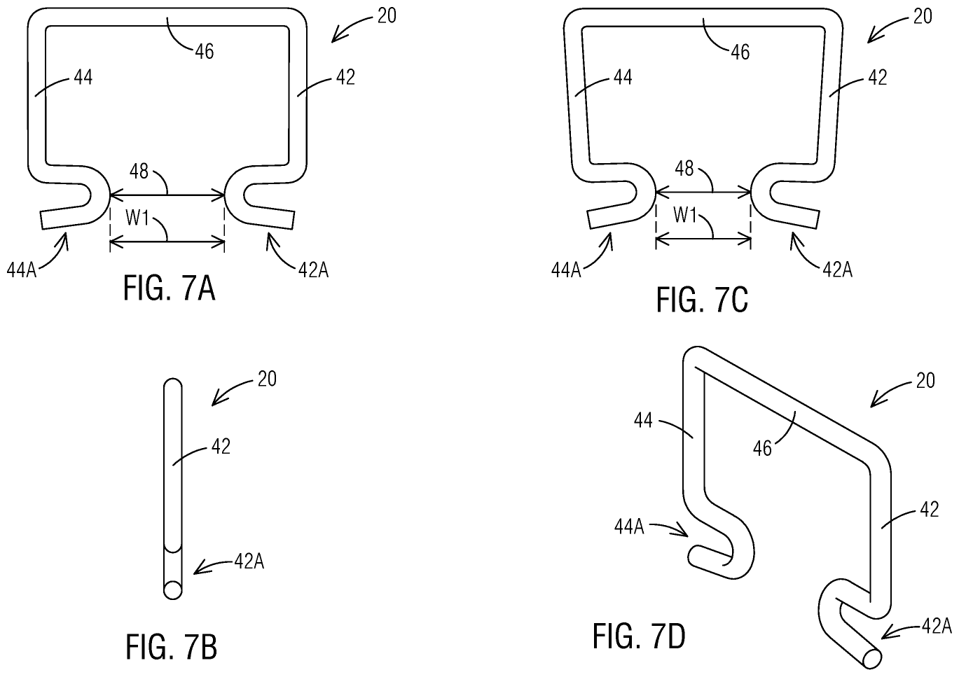

The nut plate 22 may be composed of a metal, such as stainless-steel and other known metal compositions or known composites and is preferably fabricated from known metal stamping or metal fabrication processes. Stamping processes are less expensive than machining processes that are used, for example, to manufacture the inserts that is used for receiving a bolt. The nut plate 22 shown in FIGS. 4A-6 includes a planar base plate 24 that includes a first end 24A distal a second end 24B. The term planar means having a flat surface extending in a single plane and not a curved surface or any portion of a surface of being curved, or it is completely flat, except alongside edges, which may have curves.

As further shown, the nut plate 22 may include a first hole 26 at the first end 24A of the base plate 24 and a second hole 28 at the second end 24B of the baseplate 24. The holes 26, 28 are sized to receive fasteners, such as rivets (not shown) used to secure the nut plate 22 to the panel 12 or panel 14. The base plate 24 of the nut plate 22 further includes a third hole 30 centered between the first hole 26 and the second hole 28. The third hole 30 is sized to receive the bolt 16 when aligned with holes 12A, 14B on the panels 12, 14. Holes 26, 28 are provided for receipt of rivets 23 as described above; however, the holes 26, 28 are not necessary if the nut plate 22 intended to by bonded to a panel using known adhesive compounds.

The nut plate 22 further includes a first planar wall 32 and a second planar wall 34 both of which are integrally formed with the base plate 24, are cantilevered from the base plate 24, and which are parallel to each other. To that end, the walls 32 and 34 define channel 36 therebetween to receive the insert 18. In addition, each wall 32, 34 includes a pair of notches including a first notch 38 and a second notch 40. The first notch 38 on each wall 32, 34 is disposed toward the first end 24A of the base plate 24; and the second notch 40 of each second wall 34 is disposed toward the second end 24B of the base plate 24. The notches 38, 40 of the walls 32, 34 are arranged relative to one another to receive and support the resilient retainer clip 20 shown in FIGS. 1 and FIGS. 7A-5D.

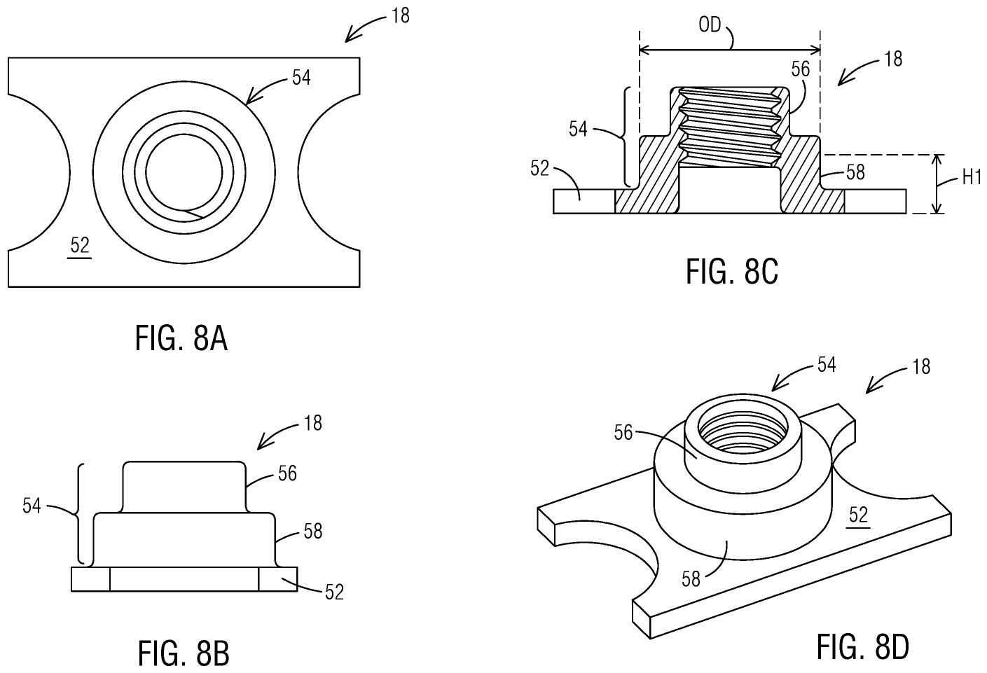

As can be seen in FIGS. 7A to 7D, the clip 20 (retention device) has a generally U-shaped configuration including a first leg 42 parallel to a second leg 44, both of which are interconnected by a third leg 46, which is extends perpendicular to each of the first and second legs 42, 44.

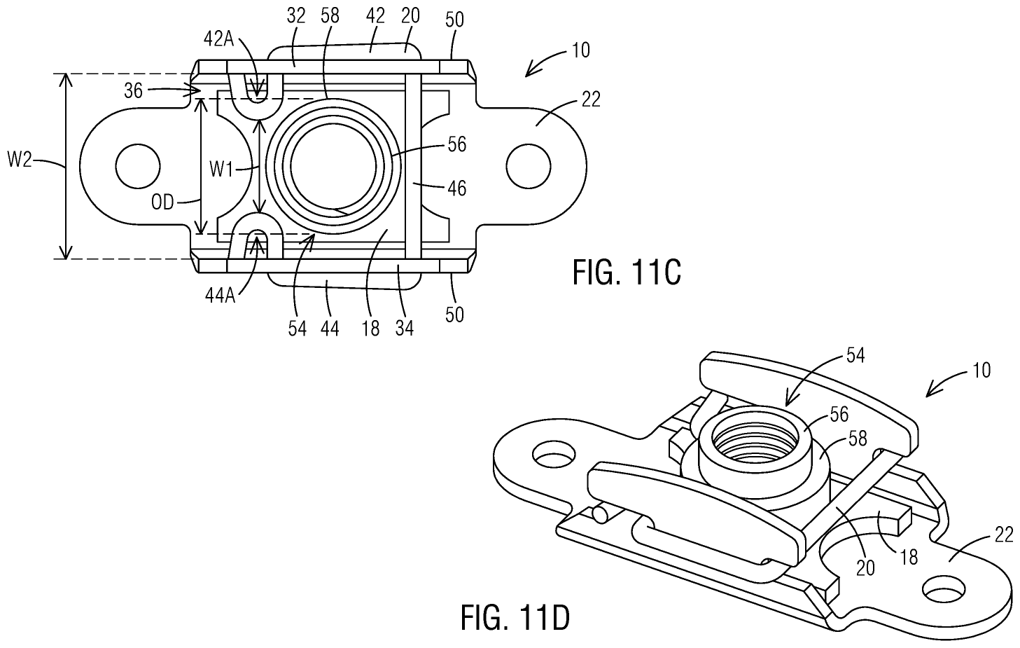

Respective first ends 42A, 44A of the legs 44, 46 or clip 20 each have a curvilinear configuration (e.g., U shaped/hook shaped) that is seated within the respective first notch 38 of each wall 32, 34. The resilient characteristic of the clip 20 is such that the first ends 42A, 44A bias toward each other. When the clip is in an installed state as shown in FIG. 7A and FIGS. 11A-11D, a width W1 of an opening 48 between the first ends 42A, 44A of the clip 20 is slightly larger than the width W1 when the clip is not installed, as shown in FIG. 7C. In the latter, the first leg 42 and the second leg 44 bias the first ends 42A, 44A toward each other. In an example embodiment, W1 in FIG. 7A is 0.23 inches and W1 in FIG. 7C is 0.22 inches. The opening is centered at a height H1 above the base 52 (see FIG. 4A). The height H1 may be selected to ensure the insert 18 can be installed over existing rivets 23, whose protrusion above the base plate might otherwise interfere with the insertion of the insert 18. As can be seen in FIG. 4A-4D, the hook shaped ends 42A, 44A extend toward each other in a lateral direction DL and parallel to each other in an axial direction DA. The first notches 38 are configured to fully receive therein an axial extent AEE of a respective hook shaped end 42A, 44A. This is made possible by an overhanging portion 32′, 34′ of the walls 32, 34 respectively, where an axial extent AEO the overhanging portion 32′, 34′ is at least as long as and axially overhangs the axial extent AEE of the respective hook shaped end 42A, 44A. In an example embodiment, the axial extent AEO the overhanging portion 32′, 34′ is greater than an axial extent AEO′ of an overhanging portion 32″, 34′″ of the walls 32, 34 respectively that overhangs the second notches 40. The overhanging portions 32′, 32″, 34′, 34″ protect the hook shaped ends 42A, 44A from being bent during installation of the insert 18 as well as during use.

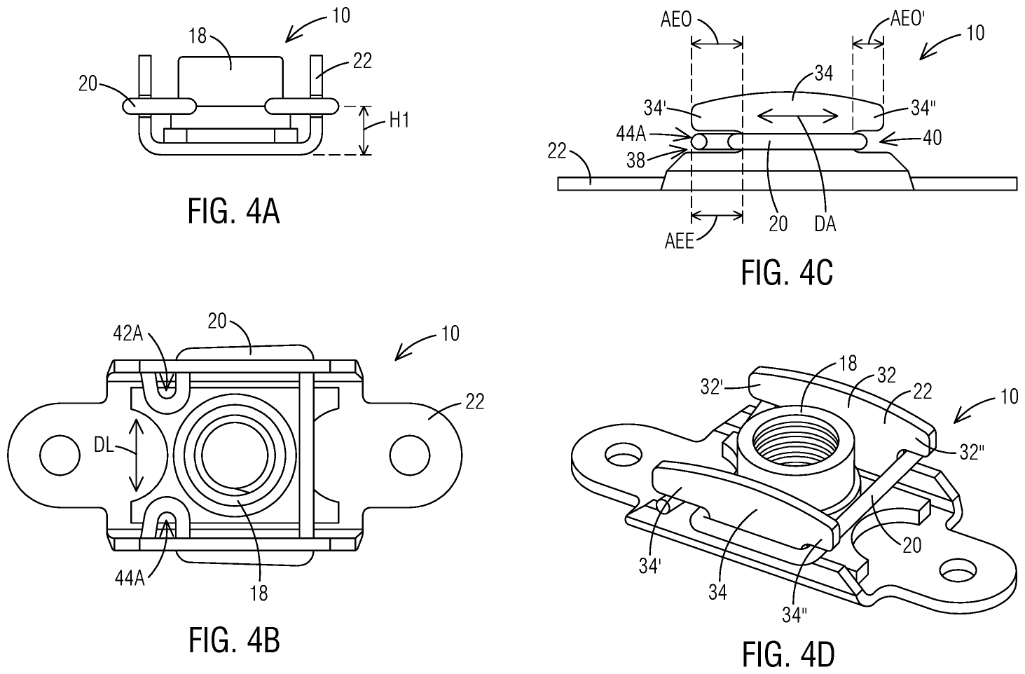

As may be appreciated from FIGS. 11A-11D, the width dimension W1 between the first ends 42A, 44A of the clip 20 is less than a width dimension W2 between the walls 32, 34 of the nut plate 22. Given the resilient nature of the clip 20, during installation the first ends 42A, 44A the first ends are forced or biased apart from one another as the ends 42A, 44A pass across respective outer surfaces 50 of the walls 32, 34. When the first end 42A, 44A approach the notches 38 of the walls 32, 34, the ends 42A, 44A bias toward one another seating within the notches 38 and securing the clip 20 to the walls 32, 34 of the nut plate 22, and consequently to the nut plate 22. To that end, the third leg 46 of the clip 20, or the respective junctions of the third leg 46 to the first leg 42, 44, are seated in the second notches 40. Once the clip 20 is seated on the nut plate 22, the insert 18 may be forced between the ends 42A, 44A of the clip 20 to create the fastener assembly 10 as shown in FIGS. 3A-3D.

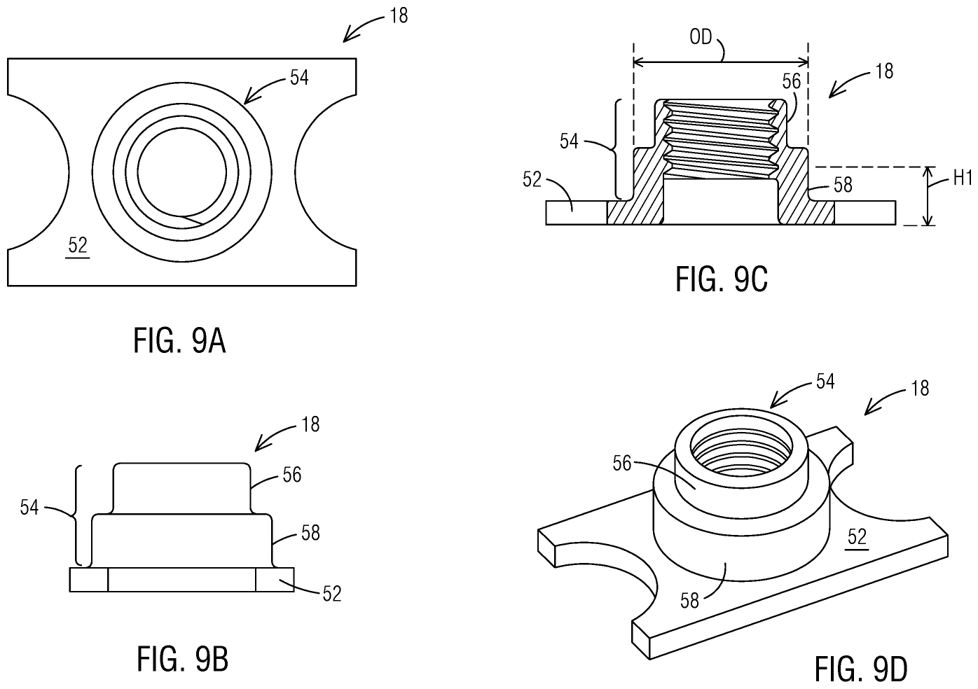

FIGS. 8A-10D show various inserts 18 according to aspects of the invention. The inserts 18 include a base 52 and a threaded receptacle 54, into which the bolt 16 is threaded to secure two panels together using the fastener assembly 10. The receptacle 54 includes cylinder 56 and optionally a shoulder 58. Certain embodiments may dispense with the shoulder 58 as will be detailed below.

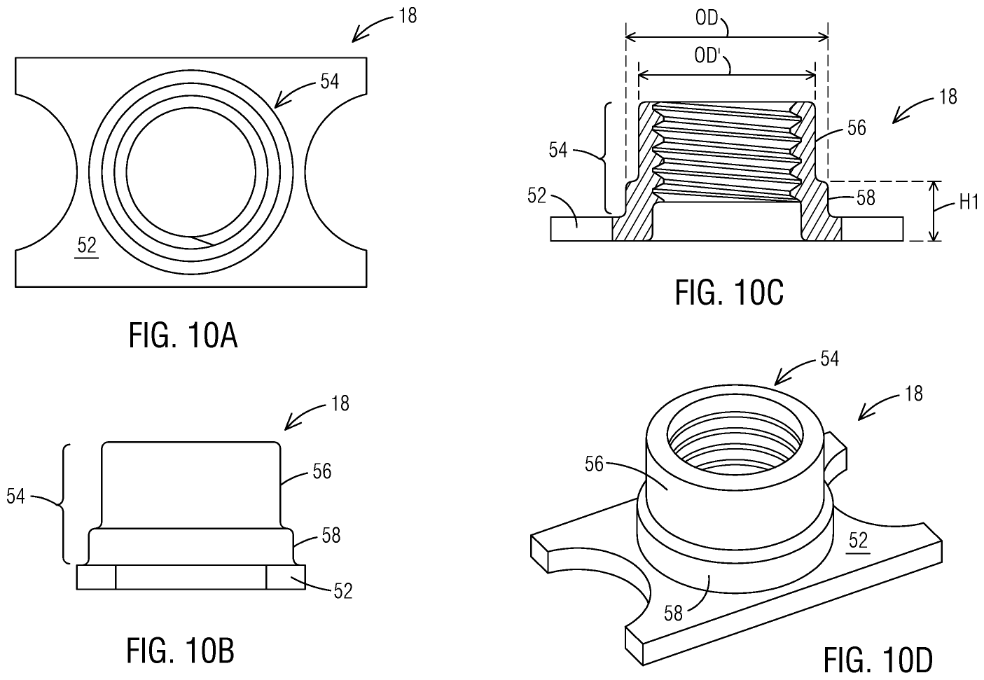

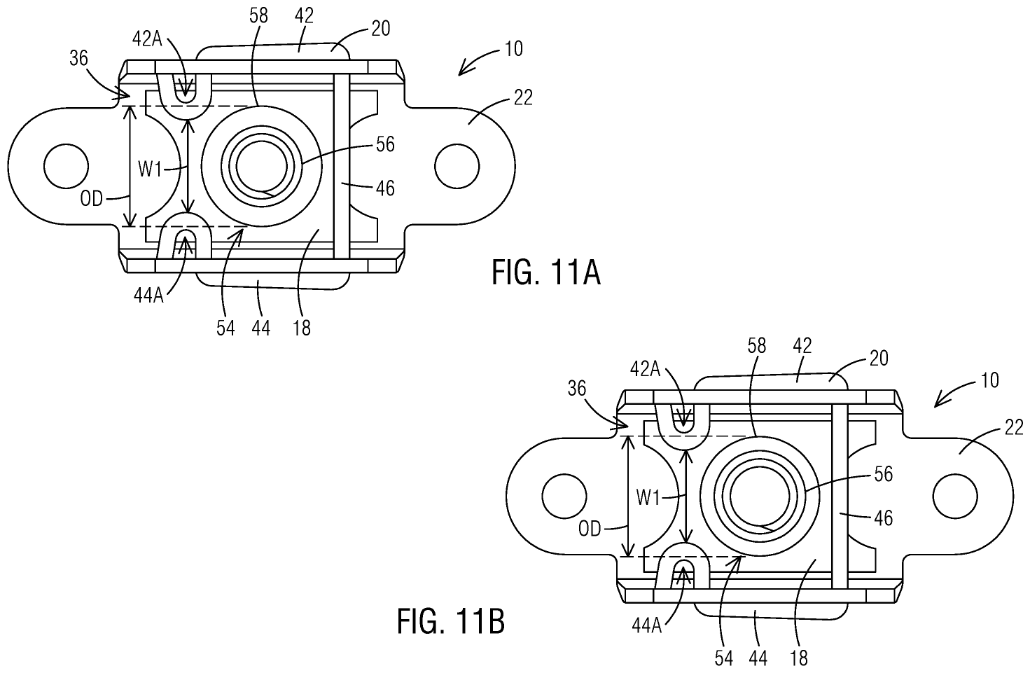

FIGS. 8A-8D show an insert 18 in which the cylinder 56 of the receptacle 54 includes an 8×32 female thread. FIGS. 9A-9D show an insert 18 in which the cylinder 56 of the receptacle 54 includes an 10×32 female thread. FIGS. 10A-10D show an insert 18 in which the cylinder 56 of the receptacle 54 includes a ¼×28 female thread.

In example embodiments, the receptacles 54 of the various sized inserts 18 all have at least one outer diameter OD that is larger than the width W1 between the first ends 42A, 44A of the clip 20 when the clip is in an installed state (such as is shown in FIG. 7A and FIGS. 11A-11D). The portion of the receptacle 54 that defines the outer diameter OD will be disposed close to or at the same height H1 so the outer diameter OD will coincide with the height H1 of the opening 48. In an example embodiment, the height H1 is 0.1 inches. In this way, when an installed insert 18 slides along the base plate 24 towards the first ends 42A, 44A of the legs 44, 46, the portion of the receptacle 54 that defines the outer diameter OD will abut the first ends 42A, 44A and thereby be prevented from leaving the channel 36. The insert 18 will only be able to get past the first ends 42A, 44A to leave the channel 36 if the insert 18 is manually forced past the first ends 42A, 44A.

The outer diameter OD that is larger than the width W1 may be an outer diameter OD of the cylinder 56 and/or the shoulder 58. In the embodiments of FIGS. 8A-8D and FIGS. 9A-9D, it is the outer diameter of at least the shoulder 58 that is larger than the width W1 and that is disposed at H1 and thereby abuts the ends 42A, 44A of the legs 44, 46 when the installed insert 18 slides along the base plate 24. In an example embodiment, the OD in FIGS. 8A-8D and FIGS. 9A-9D is 0.3 inches. In the embodiment of FIGS. 10A-10D, the outer diameter OD of the shoulder 58 is larger than the width W1 and is disposed at H1 and thereby abuts the ends 42A, 44A of the legs 44, 46 when the installed insert 18 slides along the base plate 24. In an example embodiment, the outer diameter OD of the shoulder 58 is 0.34 inches. In this example embodiment, the outer diameter of the cylinder 56 is also larger than the width W1. In an example embodiment, the outer diameter OD′ of the cylinder 56 is 0.3 inches. Consequently, in the embodiment of FIGS. 10A-10D, either the shoulder 58 or the cylinder 56 can be disposed at H1 to abut the ends 42A, 44A.

In an example embodiment, a magnitude of the outer diameter that is larger than the width W1 may be the same among different inserts 18. For example, a magnitude of the outer diameter of the shoulder 58 of the insert 18 of FIGS. 8A-8D may equal a magnitude of the outer diameter of the shoulder 58 of the insert 18 of FIGS. 9A-9D, which may be equal to a magnitude of the outer diameter of the shoulder 58 of the insert 18 of FIGS. 10A-10D. In addition, the magnitude of the outer diameter that is larger than the width W1 may be the same among different inserts 18, but may be a characteristic of different parts of the respective receptacles 54. For example, the magnitude of the outer diameter of the shoulder 58 of the insert 18 of FIGS. 8A-8D (and/or the shoulder 58 of the insert 18 of FIGS. 9A-9D) may be the same as a magnitude of the cylinder 56 of the insert 18 of FIGS. 10A-10D. It is also possible for the cylinder 56 and the shoulder 58 on a given insert 18 to have a same outer diameter. Any combination of the foregoing is possible so long as each receptacle 54 includes at least one outer diameter that is larger than the width W1 at H1 and which retains the insert 18 in the channel 36 absent the application of external force. As can be seen, in FIGS. 11A-11D, when the clip 20 is installed, the insert 18 can be installed by resting the base 52 on the base plate 24 and forcing the receptacle 54 through the opening 42 between the ends 42A, 44A of the legs 44, 46 until the receptacle 54 reaches a position between the ends 42A, 44A of the legs 44, 46 and the third leg 46. Alternately, when the clip 20 is not installed, the insert 18 can simple be placed in the channel 36 and the clip 20 installed as detailed above to retain the insert 18 in the channel 36.

FIG. 11A shows that the outer diameter of the shoulder 58 of the 8×32 insert of FIGS. 8A-8D defines the outer diameter that is larger than the width W1 between the first ends 42A, 44A of the clip 20 when the clip 20 is in an installed state. Consequently, it is an interference between the outer diameter of the shoulder 58 and the ends 42A, 44A of the legs 44, 46 that retains the insert 18 in the channel 36.

FIG. 11B shows that the outer diameter of the shoulder 58 of the 10×32 insert of FIGS. 9A-9D defines the outer diameter that is larger than the width W1 between the first ends 42A, 44A of the clip 20 when the clip 20 is in an installed state. Consequently, it is an interference between the outer diameter of the shoulder 58 and the ends 42A, 44A of the legs 44, 46 that retains the insert 18 in the channel 36.

FIG. 11C shows that the outer diameter of the shoulder 58 of the ¼×28 insert of FIGS. 10A-10D defines the outer diameter that is larger than the width W1 between the first ends 42A, 44A of the clip 20 when the clip 20 is in an installed state. Consequently, it is an interference between the outer diameter of the shoulder 58 and the ends 42A, 44A of the legs 44, 46 that retains the insert 18 in the channel 36. However, since the outer diameter OD′ of the cylinder 56 is also larger than the width W1, an interference between the outer diameter OD′ of the cylinder 56 and the ends 42A, 44A could alternately retain the insert 18.

FIG. 11D is an isometric view of the fastener assembly of FIG. 11B.

1. A fastener assembly, comprising:
a nut plate comprising: a planar base plate comprising a first end, a second end, a first hole at and through the first end, and a second hole at and through the second end; a planar first wall cantilevered from and perpendicular to the base plate; a planar second wall cantilevered from and perpendicular to the base plate and parallel to the first wall, wherein the base plate, first wall and second wall define a channel; and a third hole through the base plate between the first wall and the second wall;
wherein the first wall comprises a first pair of notches comprising a first notch disposed toward the first end of the base plate and a second disposed toward the second end of the base plate, wherein the second wall comprises a second pair of notches comprising a first notch disposed toward the first end of the base plate and a second disposed toward the second end of the base plate; and wherein the first notches of the first and second pairs of notches are dimensioned the same and the second notches of the first and second pairs of notches are dimensioned the same, and the respective first notches each have a length dimension that is the same and is greater than a length dimension of the respective second notches of first and second pairs of notches;
a resilient retention device comprising a generally U-shaped configuration with two parallel legs interconnected by a third leg and respective ends of the two parallel legs are seated in a respective first notch of the first pair of notches and extend along outside surfaces of the first and second walls relative to the channel, and the third leg is seated in the second notches of the respective pairs of notches and spanning the channel; and
a receptacle, disposed in the channel, comprising a hollow cylinder with a through-hole aligned with the third hole of the base plate, the hollow cylinder comprising internal threading, wherein the receptacle is a component separate from the nut plate and retained in the channel at least by the retention device.

2. A fastener assembly, comprising:
a nut plate comprising: a planar base plate comprising a first end, a second end, a first hole at and through the first end, and a second hole at and through the second end; a planar first wall integral with the base plate and depending therefrom perpendicular to the base plate; a planar second wall integral with base plate and depending therefrom perpendicular to the base plate and parallel to the first wall, wherein the base plate, first wall and second wall define a channel;
a resilient retention device comprising a generally U-shaped configuration with spaced apart legs interconnected by a third leg and the retention device seated against the first wall and the second wall, wherein the two spaced apart legs form an opening at an end of the retention device within the channel and between the first and second walls, and the opening comprises a width dimension;
wherein the first wall comprises a notch at a first end thereof, and the second wall comprises a notch at a first end of the wall opposite the notch of the first wall, and the notches in the first wall and the second wall have a bottom surface that is spaced an equidistance from a top surface of the planar base plate of the nut plate; and
a plurality of inserts comprising at least a first insert and a second insert wherein each of the first insert and the second insert comprises an internally threaded cylinder integrally connected to a respective planar base and a respective shoulder is disposed between the cylinder and the base;
wherein the planar base of the first insert comprises a width dimension that is equal to a width dimension of the planar base of the second insert;
wherein the shoulder of the first insert comprises an outside diameter and a height dimension that is equal to an outside diameter and a height dimension of the shoulder of the second insert, and wherein the outside diameter of the first respective shoulders is greater than the width dimension of the opening of the retention device in the channel, and the height dimension of the shoulder of each of the first insert and the second insert is greater than the equidistance the notches are spaced from the top surface of the base plate;
wherein the cylinder of the first insert comprises a first internal thread size that is not equal to a second internal thread size of the cylinder of the second insert; and
wherein, the first insert and the second insert are interchangeable in the channel of the nut plate whereby the first insert is capable of being positioned and secured in the channel of the nut plate and secured therein by the retention device separate and apart from the second insert and the second insert is capable of being positioned and secured in the channel of the nut plate and secured therein separate and apart from the first insert.

3. The fastener assembly of claim 2, further comprising a third insert that is interchangeable on the nut plate relative to the first insert and the second insert, and the third insert comprises an internally threaded cylinder integrally connected to a respective planar base:
wherein the planar base of the third insert comprises a width dimension that is equal to the width dimension of the planar base of the first insert and the second insert;
wherein the cylinder of the third insert comprises an outside diameter that is equal to the outside diameter of the shoulder of the first insert and the outside diameter of the shoulder of the second insert, and the outside diameter of the cylinder of the third insert is greater than the width dimension of the opening of the retention device in the channel; and
wherein the cylinder of the third insert comprises a third internal thread size that is not equal to the first internal thread size of the cylinder of the first insert and is not equal to the second internal thread size of the cylinder of the second insert.

4. A fastener assembly, comprising:
a nut plate comprising: a planar base plate comprising a first end and a second end; a planar first wall cantilevered from and perpendicular to the base plate; a planar second wall cantilevered from and perpendicular to the base plate and parallel to the first wall, wherein the base plate, first wall and second wall define a channel; and a hole through the base plate between the first wall and the second wall;
a resilient retention device comprising a generally U-shaped configuration with spaced apart legs interconnected by a third leg and the retention device is seated against the first wall and the second wall, wherein the two spaced apart legs form an opening at an end of the retention device within the channel and between the first and second walls, wherein the opening comprises a width dimension; wherein the first wall comprises a notch at a first end thereof, wherein the second wall comprises a notch at a first end of the wall opposite the notch of the first wall, and wherein the notches in the first wall and the second wall each have a bottom surface that is spaced an equidistance from a top surface of the planar base plate of the nut plate; and
a plurality of inserts comprising at least a first insert and a second insert wherein each of the first insert and the second insert comprises an internally threaded receptacle and the receptacle is integrally connected to a planar base;
wherein the planar base of the first insert comprises a width dimension that is equal to a width dimension of the planar base of the second insert;
wherein the receptacle of the first insert comprises an outside diameter that is greater than the width dimension of the opening of the between the two spaced apart legs of the retention device;
wherein the receptacle of the second insert comprises an outside diameter that is greater than the width dimension of the opening of the between the two spaced apart legs of the retention device;
wherein the receptacle of the first insert comprises a first internal thread size that is not equal to a second internal thread size of the receptacle of the second insert; and
wherein, the first insert and the second insert are interchangeable in the channel of the nut plate whereby the first insert is capable of being positioned and secured in the channel of the nut plate and secured therein by the retention device separate and apart from the second insert and the second insert is capable of being positioned and secured in the channel of the nut plate and secured therein separate and apart from the first insert.

5. The fastener assembly of claim 4, wherein the receptacle of the first insert comprises a hollow internally 8×32 threaded cylinder and a shoulder between the cylinder and the base that defines an outside diameter of the receptacle of the first insert, and the receptacle of the second insert comprises a hollow internally 10×32 threaded cylinder and a shoulder between the cylinder and the base, and the outside diameter of the receptacle is defined by the shoulder.

6. The fastener assembly of claim 5, further comprising a third insert that comprises an internally ¼×28 threaded receptacle integrally connected to a respective planar base, and the receptacle of the third insert comprises a hollow internally threaded cylinder and a shoulder between the cylinder and the base, and an outside diameter of the receptacle is defined by the shoulder and is equal to the outside diameter of the first insert and the outside diameter of the second insert;
wherein the planar base of the third insert comprises a width dimension that is equal to the width dimension of the planar base of the first insert and the second insert; and
wherein, the first insert, the second insert and the third insert are interchangeable in the channel of the nut plate.

7. A fastener assembly, comprising:
a nut plate comprising a base plate, a first wall cantilevered from the base plate, and a second wall cantilevered from the base plate, wherein the nut plate defines a channel between the first wall and the second wall, and wherein the first wall and the second wall collectively define a first pair of notches at a first end of the channel and a second pair of notches at a second end of the channel;
a concave and resilient retention device comprising two legs and a base leg there between, wherein each leg of the two legs defines a hook shaped end that is opposite the base leg, wherein the first pair of notches is configured to receive therein the hook shaped ends of the retention device and the second pair of notches is configured to receive therein the base leg of the retention device; and
an insert comprising an internally threaded cylinder connected to a respective planar base and a shoulder disposed between the cylinder and the base, wherein an outer diameter of the cylinder is larger than a distance between the hooked shaped ends of the legs such that when the retention device is installed in the first pair of notches and the second pair of notches the retention device traps the insert in the channel.

8. The fastener assembly of claim 7, wherein first notches of the first pair of notches are larger than second notches of the second pair of notches.

9. The fastener assembly of claim 7, wherein when the retention device is installed in the first pair of notches and the second pair of notches, the hook shaped ends of the retention device extend toward each other in a lateral direction and parallel to each other in an axial direction, and first notches of the first pair of notches are configured to fully receive therein an axial extent of a respective hook shaped end.
